(19) United States
(12) Patent Application Publication
(10) Pub. No.: US 2026/0362356 A1
(43) Pub. Date: Nov. 12, 2026

(54) METHOD AND APPARATUS FOR INDICATING SYNCHRONIZATION SIGNAL BLOCK

(71) Applicant: 1FINITY Inc., Kawasaki-shi (JP)

(72) Inventors: Jing ZHU, Beijing (CN); Lei ZHANG, Beijing (CN)

(73) Assignee: 1FINITY Inc., Kawasaki-shi (JP)

(21) Appl. No.: 19/745,267

(22) Filed: Jul. 17, 2026

Related U.S. Application Data
(63) Continuation of application No. PCT/CN2024/073103, filed on Jan. 18, 2024.

(51) Int. Cl. H04W 56/00; H04W 72/232

(52) U.S. Cl. CPC H04W 56/0025; H04W 72/232

(57) ABSTRACT

An apparatus for indicating synchronization signal block (SSB), configured in a terminal equipment, includes: a receiver configured to receive N SSB configurations from a network device, where N≥2, wherein the N SSB configurations are carried by radio resource control (RRC) signaling, and processor circuitry configured to activate at least one of the N SSB configurations.

### CROSS-REFERENCE TO RELATED APPLICATION

This application is a continuation application under 35 U.S.C. 111(a) of International Patent PCT/CN2024/073103 filed on Jan. 18, 2024, and designated the U.S., the entire contents of which are incorporated herein by reference.

### TECHNICAL FIELD

Embodiments of the present disclosure relate to the technical field of communications.

### BACKGROUND

As an important constituent part of global new-type infrastructure construction, a 5G communication network has experienced rapid development all over the world in recent years. As network scales are getting larger and larger, operators' energy consumption keeps rising. By taking data released by the Ministry of Industry and Information Technology of China as an example, energy consumption will increase by approximately 80% in 2022 compared with 2015.

With construction of 5G and large-scale commercialization of a 5G Active Antenna Unit (AAU). Compared with a Remote Radio Unit (RRU) mainly used in 3G and 4G, since power consumption of the AAU is relatively large, its energy consumption will also increase in multiples. 5G defines three service types, i.e., Enhanced Mobile Broadband (eMBB), massive Machine Type of Communication (mMTC) and Ultra Reliable Low Latency Communication (URLLC), resulting in a continuous increase of bursty small-packet services in 5G, with operating 24 hours a day without interruption for a base station. Average daily energy consumption of a 5G site will also be more than twice that of a 4G site.

3GPP introduces key technologies such as Massive MIMO and a larger radio frequency bandwidth in the 5G era. 5G supports higher data rates and greater data traffic, requiring more transmission bandwidths. Deployment of high-frequency bands will also be main frequency bands for future expansion of 5G. However, high-frequency band transmission characteristics limit a coverage range of a site, thus making deployment of a 5G site denser. Moreover, energy consumption brought by increasing sites will impose a huge operational cost pressure on operators. Therefore, network energy saving has important significance for saving operating costs, and 5G network energy saving is an urgent problem to be solved.

To achieve energy saving, a network device may perform energy-saving processing respectively in aspects of time domain, frequency domain, spatial domain and/or energy domain, according to a network load situation. For example, in aspects of spatial domain and energy domain, a network device may turn off some antennas when a load is lower to achieve a purpose of energy saving. In the aspect of time domain, a network device may adjust a period or time-domain position of a cell common reference signal (e.g., SSB/SIB) in case of few users and small loads, so as to achieve a purpose of energy saving in a network device.

It should be noted that the above introduction to the technical background is just to facilitate a clear and complete description of technical solutions of the present disclosure, and is elaborated to facilitate understanding of those skilled in the art. It cannot be considered that the technical solutions are known by those skilled in the art just because these solutions are elaborated in Background of the present disclosure.

### SUMMARY

Inventors find that how to flexibly adjust transmission of a synchronization signal block (SSB) to achieve a purpose of energy saving without affecting normal transmission by a terminal equipment has become an urgent problem to be solved in network energy saving technologies.

For at least one of the above problems, embodiments of the present disclosure provide a method and an apparatus for indicating synchronization signal block.

According to one aspect of embodiments of the present disclosure, a method for indicating synchronization signal block (SSB) is provided, including that:
a terminal equipment receives N synchronization signal block (SSB) configurations from a network device, where N≥1; and/or,
the terminal equipment receives radio resource control (RRC) signaling and/or a media access control control element (MAC CE) and/or downlink control information (DCI); the RRC signaling and/or MAC CE and/or DCI being used to indicate/activate/trigger one of the N SSB configurations.

According to another aspect of embodiments of the present disclosure, an apparatus for indicating synchronization signal block (SSB) is provided, including:
a receiving unit configured to receive N synchronization signal block (SSB) configurations from a network device, where N≥1; and/or, receive radio resource control (RRC) signaling and/or a media access control control element (MAC CE) and/or downlink control information (DCI); the RRC signaling and/or MAC CE and/or DCI being used to indicate/activate/trigger one of the N SSB configurations.

According to another aspect of embodiments of the present disclosure, a method for indicating synchronization signal block (SSB) is provided, including that:
a network device transmits N synchronization signal block (SSB) configurations to a terminal equipment, where N≥1; and/or,
the network device transmits radio resource control (RRC) signaling and/or a media access control control element (MAC CE) and/or downlink control information (DCI) to the terminal equipment; the RRC signaling and/or MAC CE and/or DCI being used to indicate/activate/trigger one of the N SSB configurations.

According to another aspect of embodiments of the present disclosure, an apparatus for indicating synchronization signal block (SSB) is provided, including:
a transmitting unit configured to transmit N synchronization signal block (SSB) configurations to a terminal equipment, where N≥1; and/or, transmit radio resource control (RRC) signaling and/or a media access control control element (MAC CE) and/or downlink control information (DCI) to the terminal equipment; the RRC signaling and/or MAC CE and/or DCI being used to indicate/activate/trigger one of the N SSB configurations.

According to a further aspect of embodiments of the present disclosure, a communication system is provided, including:
a network device configured to transmit N synchronization signal block (SSB) configurations to a terminal equipment, where N≥1; and/or, transmit radio resource control (RRC) signaling and/or a media access control control element (MAC CE) and/or downlink control information (DCI) to the terminal equipment; and
a terminal equipment configured to receive the N synchronization signal block (SSB) configurations; and/or, receive radio resource control (RRC) signaling and/or a media access control control element (MAC CE) and/or downlink control information (DCI); the RRC signaling and/or MAC CE and/or DCI being used to indicate/activate/trigger one of the N SSB configurations.

One of advantageous effects of embodiments of the present disclosure lies in that in some scenarios (e.g., an energy-saving mode) of wireless communication applications, a network device and a terminal equipment are able to quickly and flexibly adjust SSB transmission, which is able to not only increase network gains (such as energy-saving gains), but also is able to ensure normal transmission by a terminal equipment.

Referring to later descriptions and drawings, specific implementations of the present disclosure are disclosed in detail, indicating modes in which principles of the present disclosure may be adopted. It should be understood that implementations of the present disclosure are not limited in scope thereby. Within spirits and scopes of terms of attached claims, implementations of the present disclosure include many changes, modifications, and equivalents.

Feature(s) described and/or shown for one implementation may be used in one or more other implementations in the same way or in a similar way, and may be combined with or replace feature(s) in other implementations.

It should be emphasized that term “include/comprise” when being used herein refers to presence of a feature, a whole piece, a step, or a component, but does not exclude presence or addition of one or more other features, whole pieces, steps, or components.

### BRIEF DESCRIPTION OF DRAWINGS

Element(s) and feature(s) described in one drawing or one implementation of embodiments of the present disclosure may be combined with element(s) and feature(s) shown in one or more other drawings or implementations. In addition, in the drawings, similar reference signs denote corresponding components in several drawings, and may be used to indicate corresponding components used in more than one implementation.

FIG. 1 is a schematic diagram of a communication system in embodiments of the present disclosure;

FIG. 2 is a schematic diagram of a time-frequency structure of an SSB;

FIG. 3 is a schematic diagram of a method for indicating synchronization signal block (SSB) in embodiments of the present disclosure;

FIG. 4 is an example diagram of an SSB in embodiments of the present disclosure;

FIG. 5 is an example diagram of an SSB pattern in embodiments of the present disclosure;

FIG. 6 is an example diagram of SSB configuration 0 in embodiments of the present disclosure;

FIG. 7 is an example diagram of SSB configuration 2 in embodiments of the present disclosure;

FIG. 8 is an example diagram of SSB configuration 3 in embodiments of the present disclosure;

FIG. 9 is an example diagram of SSB configuration 4 in embodiments of the present disclosure;

FIG. 10 is a schematic diagram of a method for indicating synchronization signal block (SSB) in embodiments of the present disclosure;

FIG. 11 is a schematic diagram of an apparatus for indicating synchronization signal block (SSB) in embodiments of the present disclosure;

FIG. 12 is a schematic diagram of an apparatus for indicating synchronization signal block (SSB) in embodiments of the present disclosure;

FIG. 13 is a schematic diagram of a terminal equipment in embodiments of the present disclosure; and

FIG. 14 is a schematic diagram of a network device in embodiments of the present disclosure.

### DETAILED DESCRIPTION

Referring to the drawings, through the following Specification, the aforementioned and other features in the present disclosure will become obvious. The Specification and the drawings specifically disclose specific implementations of the present disclosure, indicating partial implementations in which principles of the present disclosure may be adopted. It should be understood that the present disclosure is not limited to described implementations, on the contrary, the present disclosure includes all modifications, variations and equivalents falling within scopes of attached claims.

In embodiments of the present disclosure, terms “first” and “second”, etc. are used to distinguish different elements in terms of appellation, but do not represent a spatial arrangement or time sequence, etc. of these elements, and these elements should not be limited by these terms. Term “and/or” includes any one of and all combinations of one or more of relevantly listed terms. Terms “contain”, “include” and “have”, etc. refer to presence of stated feature(s), element(s), component(s), or assembly/assemblies, but do not exclude presence or addition of one or more other features, elements, components, or assemblies.

In embodiments of the present disclosure, singular forms “a/an” and “the”, etc. include plural forms, and should be understood broadly as “a kind of” or “a type of”, but are not defined as the meaning of “one”, in addition, term “the” should be understood to include both singular forms and plural forms, unless a context clearly indicates otherwise. In addition, term “according to” should be understood as “at least partially according to . . . ”, and term “based on” should be understood as “at least partially based on . . . ”, unless a context clearly indicates otherwise.

In embodiments of the present disclosure, term “communication network” or “wireless communication network” may refer to a network conforming to any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be performed according to a communication protocol of any stage, for example which may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in future.

In embodiments of the present disclosure, term “network device” e.g. refers to a device configured to access a terminal equipment to a communication network in a communication system and provide services for the terminal equipment. A network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., moreover, may further include a Remote Radio Head (RRH), a Remote Radio Unit (RRU), a relay or low power node (such as femeto, pico, etc.). And term “base station” may include some or all functions thereof, and each base station may provide communication coverage to a specific geographic region. Term “cell” may refer to a base station and/or a coverage area thereof, which depends on a context in which this term is used.

In embodiments of the present disclosure, term “User Equipment (UE)” or “Terminal Equipment (TE) or Terminal Device” refers to e.g. a device configured to access a communication network and receive network services via a network device. A terminal equipment may be fixed or mobile, and may also be called a Mobile Station (MS), a terminal, a Subscriber Station (SS), an Access Terminal (AT), a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under scenarios such as Internet of Things (IoT), the terminal equipment may further be a machine or an apparatus for performing monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, term “network side” or “network device side” refers to a side of a network, may be a certain base station, or may include one or more of the above network devices. Term “user side” or “terminal side” or “terminal equipment side” refers to a side of a user or terminal, may be a certain UE, or may include one or more of the above terminal equipments. Unless otherwise specified herein, “device” may refer to a network device, or may refer to a terminal equipment.

Scenarios of embodiments of the present disclosure are described below through examples, however the present disclosure is not limited thereto.

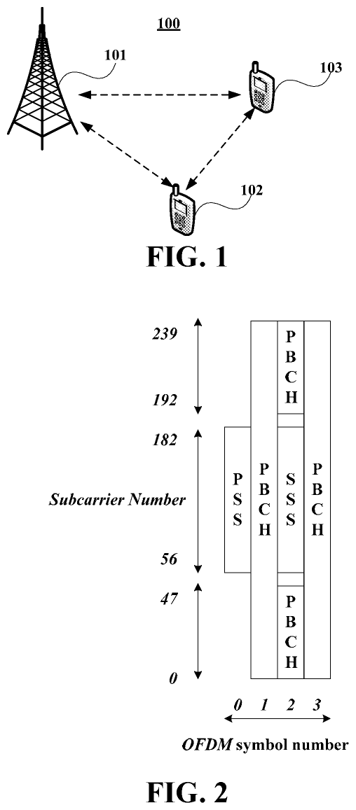

FIG. 1 is a schematic diagram of a communication system in embodiments of the present disclosure, schematically describing a situation by taking a terminal equipment and a network device as an example, and as shown in FIG. 1, a communication system 100 may include a network device 101 and terminal equipments 102, 103. For simplicity, FIG. 1 only takes two terminal equipments and one network device as an example for description, however embodiments of the present disclosure are not limited thereto.

In embodiments of the present disclosure, transmission of existing services or future implementable services may be performed between the network device 101 and the terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that two terminal equipments 102 and 103 are all within a coverage range of the network device 101, however the present disclosure is not limited thereto. Two terminal equipments 102 and 103 may be not within the coverage range of the network device 101, or one terminal equipment 102 is within the coverage range of the network device 101 while the other terminal equipment 103 is outside the coverage range of the network device 101.

System message designing is one of important concepts in wireless communication systems. A cell-level system message is mainly used to configure cell camping, provide user access, and facilitate inter-operation, etc. 5G NR simplifies system messages to a certain extent. Compared to 4G, different designs are made in terms of synchronization signal and system message designing. Therefore, it is necessary to have a renewed understanding.

Unlike a cell downlink synchronization signal and a physical broadcast channel are designed separately in 4 G, a cell Synchronization Signal (SS) and a Physical Broadcast Channel (PBCH) are coupled to a certain extent in 5G, and appear in the form of an SS/PBCH block, referred to as a Synchronization Signal Block (SSB).

FIG. 2 is a schematic diagram of a time-frequency structure of an SSB. As shown in FIG. 2, in 5GNR, an SSB occupies 20 consecutive physical resource blocks (PRBs) of a frequency domain resource, with a total of up to 240 consecutive resource elements (REs), wherein synchronization signals (including a Primary Synchronization Signal (PSS) and a Secondary Synchronization Signal (SSS)) occupy 127 consecutive REs in a first OFDM symbol and a third OFDM symbol of an SSB, respectively, and a frequency-domain center position of an SSB may be flexibly configured and adjusted locally.

After achieving SSB synchronization through frequency search, a UE decodes a Master Information Block (MIB) in a physical broadcast channel. In an LTE system, in addition to configuring an MIB, a cell further configures SIB1 according to a fixed transmission period, and transmits necessary parameter configurations required for parsing SIB2 to SIBN via SIB1. 5G NR provides an optimization mechanism for system message configuration, i.e., on-demand configuration. In principle, SIB1 does not necessarily have to be configured according to a fixed period. However, SIB1 conveys important information related to cell selection. Even if it is not configured according to a fixed period, it still needs to be configured semi-statically via RRC signaling. Due to limited content carried by a PDCCH, and because a cell-level system message generally does not change dynamically, when designing, generally a PDCCH is not adopted to carry system messages, and in 5G NR, configuration is achieved semi-statically via an RRC message.

This design concept of “on-demand configuration” of a system message in 5G NR greatly reduces resource occupation overhead of a system message, meanwhile a terminal equipment may also reduce, to a certain extent, power consumption caused by periodically monitoring system messages. In 5G NR, whether SIB1 is configured in a PDCCH common search space CORESET #0 is determined via a parameter ssb-SubcarrierOffset in an MIB, the parameter indicates a subcarrier offset of an SSB's frequency-domain starting position relative to a common PRB. For 5G cell carrier frequencies for FR1 (sub 6 GHz) bands, a UE jointly determines a subcarrier offset of an SSB relative to a common PRB by combining 1-bit time-domain payload additionally indicated in a PBCH with a value range of 0 to 31. If the value is not greater than 23, a UE considers that the cell has configured a system message SIB1; otherwise, content carried by SIB1 does not appear in the form of a system message. For 5G cell carrier frequencies for FR2 bands, a UE determines a subcarrier offset only via a parameter ssb-SubcarrierOffset, with a value range of 0 to 15. If the value is not greater than 11, a UE considers that the cell has configured a system message SIB1; otherwise, content carried by SIB1 does not appear in the form of a system message. If the parameter is not configured, a UE determines a frequency-domain subcarrier offset of an SSB through frequency search.

For different subcarrier spacings, candidate positions of an SSB transmitted per a half-frame are defined as follows:

A: a subcarrier spacing of 15 kHz, for an NR carrier frequency not greater than 3 GHz within an FR1 band, a candidate transmission occasion for an SSB may be configured in OFDM positions {2, 8} within slots 0 and 1, there are 4 candidate occasions in total; for an NR carrier frequency greater than 3 GHz within an FR1 band, a candidate transmission occasion for an SSB is configured in OFDM positions {2, 8} within slots 0, 1, 2 and 3, there are 8 candidate occasions in total.

B: a subcarrier spacing of 30 kHz, for an NR carrier frequency not greater than 3 GHz within an FR1 band, a candidate transmission occasion for an SSB may be configured in OFDM positions {4, 8, 16, 20} calculated starting from slot 0, there are 4 candidate occasions in total; for an NR carrier frequency greater than 3 GHz within an FR1 band, a candidate transmission occasion for an SSB is configured in OFDM positions {4, 8, 16, 20} calculated respectively starting from slots 0 and 2, there are 8 candidate occasions in total.

C: a subcarrier spacing of 30 kHz, in a 5G FDD spectrum mode, for an NR carrier frequency not greater than 3 GHz within an FR1 band, a candidate transmission occasion for an SSB may be configured in OFDM positions{2, 8} within slots 0 and 1, there are 4 candidate occasions in total; for an NR carrier frequency greater than 3 GHz within an FR1 band, a candidate transmission occasion for an SSB is configured in OFDM positions{2, 8} within slots 0, 1, 2 and 3, there are 8 candidate occasions in total; in a 5G TDD spectrum mode, for an NR carrier frequency not greater than 2.4 GHz within an FR1 band, a candidate transmission occasion for an SSB may be configured in OFDM positions{2, 8} within slots 0 and 1, there are 4 candidate occasions in total; and for an NR carrier frequency greater than 2.4 GHz within an FR1 band, a candidate transmission occasion for an SSB is configured in OFDM positions{2, 8} within slots 0, 1, 2 and 3, there are 8 candidate occasions in total.

D: a subcarrier spacing of 120 kHz, for an NR carrier frequency within an FR2 band, a candidate transmission occasion for an SSB is configured in OFDM positions {4, 8, 16, 20} calculated respectively starting from slots 0, 2, 4, 6, 10, 12, 14, 16, 20, 22, 24, 26, 30, 32, 34 and 36, there are 64 candidate occasions in total.

E: a subcarrier spacing of 240 kHz, for an NR carrier frequency within an FR band, a candidate transmission occasion for an SSB is configured in OFDM positions {8, 12, 16, 20, 32, 36, 40, 44} calculated respectively starting from slots 0, 4, 8, 12, 20, 24, 28 and 32, there are 64 candidate occasions in total.

For SSB candidate position patterns A, B, C, D, E transmitted within a half-frame, a UE may determine a specific index position of a currently transmitted SSB by decoding PBCH payload bits, and for a half-frame including four SSB candidate transmission positions, an index is determined via two Lowest Significant Bits (LSBs), while for a half-frame including eight SSB candidate transmission positions, an index is determined via three Lowest Significant Bits (LSBs). In both cases, a PBCH index precisely has a one-to-one correspondence with an initial sequence index of a pseudo-random sequence of a DMRS in SSBs, and when determining two LSBs or three LSBs, a UE does not obtain the index directly by decoding PBCH transmission bits, but performs logical mapping indirectly by decoding DMRSs. For half-frame including 64 SSB candidate transmission positions, an index of a DMRS in a transmitted SSB is cyclically mapped (eight SSB cycles) according to three LSBs, and a UE jointly determine a transmission index of an SSB by combining three Lowest Significant Bits (LSBs) with three additional Most Significant Bit (MSBs) of a PBCH payload. APBCH payload has 32 bits in total, including 23 bits carrying RRC contents, and in these 23 bits, 6 bits serve as 6 high bits for calculating radio frames. In addition to these 23 bits, an additional 4 bits associated with a transmission occasion at a physical layer serve as 4 low bits for calculating radio frames, 1 bit serves as a half-frame identifier in a radio frame, 3 bits serve as 3 high bits for determining SSB indices, and the remaining 1 bit is not specified by protocols, and a MAC entity performs padding to align with transport bytes.

An SSB pattern provides possible candidate positions of SSBs and a maximum value Lₘₐₓ of an SSB, within an SSB burst set (SS-burst). The number of actually activated SSBs may be less than Lₘₐₓ. A base station informs a UE which specific SSBs are activated for use via SIB1 or a higher-layer parameter ssb-PositionInBurst of a UE specific RRC signaling. For SSB-related RRC parameters, relevant technologies may be referred to.

The above schematically describes SSB-related contents in embodiments of the present disclosure, the present disclosure is not limited thereto. Inventors find that currently, SSB information such as an SSB period (ssb-periodicityServingCell) and a time-domain position (ssb-PositionInBurst) of an activated SSB within an SS-burst is configured via RRC parameters. If a network device needs to adjust configuration information of an SSB, such adjustment may only be achieved via an RRC reconfiguration message, thereby resulting in longer change time and an inability to quickly and flexibly adjust SSBs.

In embodiments of the present disclosure, higher-layer signaling may be e.g. radio resource control (RRC) signaling; for example, is called an RRC message, e.g. including an MIB, system information, and a dedicated RRC message; or is called an RRC information element (RRC IE).

The higher-layer signaling may further be e.g. Medium Access Control (MAC) signaling; or is called a MAC control element (MAC CE). However, the present disclosure is not limited thereto.

In network energy-saving scenarios, for example, when an antenna configuration changes, how to perform resource mapping via a PDSCH is an urgent problem to be solved. In the following descriptions, without causing confusion, terms “PDCCH” and “Physical Downlink Control Channel” or “Downlink Control Information” are interchangeable, and terms “PDSCH” and “Physical Downlink Shared Channel” or “Downlink Data” are also interchangeable.

Moreover, transmitting or receiving a PDCCH may be understood as transmitting or receiving downlink control information carried by a PDCCH; transmitting or receiving a PDSCH may be understood as transmitting or receiving downlink data carried by a PDSCH. In embodiments of the present disclosure, terms “indicate,” “activate” and “trigger” are interchangeable, or two or more of them may be combined for use.

### Embodiments of a First Aspect

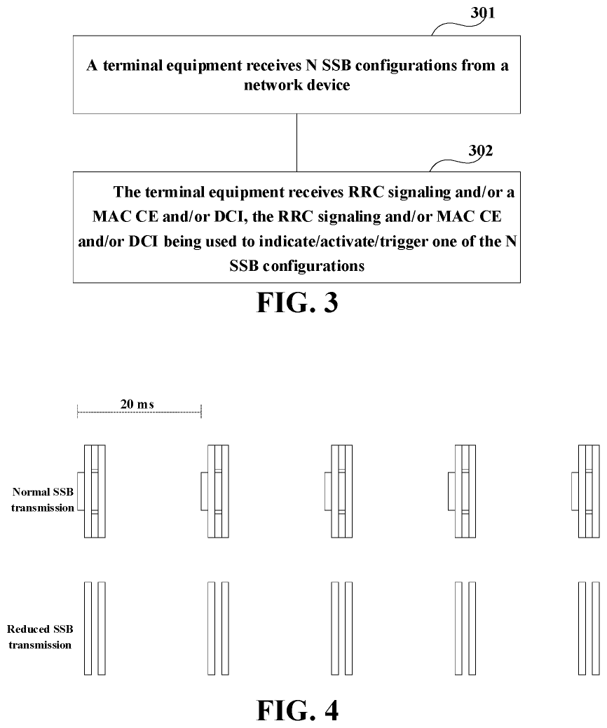

Embodiments of the present disclosure provide a method for indicating synchronization signal block (SSB), which is described from a terminal equipment side. FIG. 3 is a schematic diagram of a method for indicating synchronization signal block (SSB) in embodiments of the present disclosure, as shown in FIG. 3, the method includes:
301, a terminal equipment receives N synchronization signal block (SSB) configurations from a network device, where N≥1; and
302, the terminal equipment receives radio resource control (RRC) signaling and/or a media access control control element (MAC CE) and/or downlink control information (DCI); the RRC signaling and/or MAC CE and/or DCI being used to indicate/activate/trigger one of the N SSB configurations.

It is worth noting that the above FIG. 3 only schematically describes embodiments of the present disclosure, however the present disclosure is not limited thereto. For example, an execution sequence of operations may be adjusted appropriately, moreover some other operations may be added or certain operations therein may be removed. Those skilled in the art may make appropriate modifications according to the above contents, not being limited to records in the above FIG. 3.

In some embodiments, an SSB configuration may be transmitted via RRC signaling. A network device may configure at least one SSB configuration for a terminal equipment. An SSB configuration is associated with a first serving cell/a first carrier, that is, the N synchronization signal block (SSB) configurations come from the first serving cell/the first carrier, and/or a network device configures N synchronization signal block (SSB) configurations to the first serving cell/the first carrier. The first serving cell/the first carrier is a secondary cell, and/or, the first serving cell/the first carrier is a primary cell.

For example, the first serving cell is a secondary cell, and the secondary cell refers to a serving cell that serves as only a secondary cell but not a primary cell of a UE. For example, if one serving cell is a primary cell of some UEs, SSBs of the serving cell are not able to be adjusted, or a network device is not able to perform configuration and activation/indication/triggering of an SSB configuration in the serving cell, and it is sufficient to operate according to SSBs configured by an existing protocol. For another example, SSBs in embodiments of the present disclosure are only applicable to secondary cells (Adaptation of SSB is applicable to the serving cell which is only used as SCell).

For another example, the first serving cell may be a primary cell or may be a secondary cell.

Regarding carrying of SSB configurations: for example, a first serving cell is a primary cell, in Rel-19 NES scenarios, a network device may configure at least one SSB configuration for the primary cell, e.g., at least one SSB configuration is included in SIB1 or an RRC reconfiguration message of a primary cell; for another example, a first serving cell is a secondary cell, in Rel-19 NES scenarios, a network device may configure at least one SSB configuration for the secondary cell. For example, secondary cell configuration information (SCellConfig->sCellConfigCommon: servingCellConfigCommon) includes at least one SSB configuration, and/or includes one SSB configuration list. At least one SSB configuration configured for the primary cell or the secondary cell includes SSB configurations in existing protocols and SSB configurations supported and/or enhanced by Rel-19 NES, wherein at least one SSB configuration has a default SSB, the default configuration is an SSB configuration in existing protocols or an non-SSB configuration o, and/or an SSB configuration in existing protocols is a default SSB, and the at least one SSB configuration is an SSB configuration supported and/or enhanced by Rel-19 NES.

In some embodiments, an SSB configuration includes at least one of the following: an SSB period, an SSB time-domain position indication, an SSB subframe/half-frame index/offset or an SSB time offset, an SSB frequency, an SSB subcarrier spacing, SSB power, an SSB duration, the number of SSBs, or an SSB transmitting timer. The present disclosure is not limited thereto, the SSB configuration may further include other parameters.

For example, one SSB configuration at least includes one of the following information:
an SSB time-domain position indication parameter, or an SSB beam/spatial indication parameter, or an indication parameter of an activated SSB within an SS-burst, the parameter may reuse a parameter ssb-PositionsInBurst, or a parameter e.g. ssb-PositionsInBurst-r19 is newly defined. The parameter is used to indicate time-domain position parameter of an SSB transmitted in an SS-burst, or to indicate whether an SS within an SSB burst is activated/triggered, the parameter is able to implement management/adjustment of an SSB per beam. For example, the parameter ssb-PositionsInBurst=10000000 indicates that only an SSB corresponding to Beam 0 is activated within the SSB burst, thereby implementing management/adjustment of an SSB per beam;
an SSB period parameter, the parameter being used to indicate a period of an SSB, a parameter ssb-periodicityServingCell may be reused, or a parameter e.g. ssb-Periodicity-r19 may be newly defined;
a parameter related to an SSB frequency, the parameter being used to indicate a frequency of an SSB, a parameter absoluteFrequencySSB may be reused, or a parameter e.g. ssbFrequency-r19 may be newly defined;
a parameter related to an SSB subcarrier spacing, the parameter being used to indicate a subcarrier spacing of an SSB, a parameter ssb-SubcarrierOffset may be reused, or a parameter e.g. ssb-SubcarrierOffset-r19 may be newly defined;
an SSB subframe/half-frame index/offset or SSB time offset parameter, the parameter being used to indicate whether an SSB is in a first half-frame or a second half-frame, and/or indicate a subframe offset of an SSB, and/or indicate a time offset relative to SFN0 slot0, and/or indicate an SFN offset.
a parameter related to an SSB duration/the number of SSBs, the parameter being used to indicate the number of SSB periods or an SSB duration. For example, the parameter related to an SSB duration/the number of SSB periods is used to indicate a current SSB duration, and/or the number of SSBs, and/or the number of SSB periods; for another example, if the parameter is present in SSB configurations, it means that an SSB persists for the parameter duration, and if the parameter is absent, it means that an SSB is transmitted periodically; or
an SSB transmitting timer, the parameter being a timer for indicating whether an SSB is transmitted, normal running of a timer indicates that an SSB is transmitted, and expiry of a timer indicates that SSB transmission stops. For example, the SSB transmitting timer is used to indicate an SSB transmission duration. During a period in which an SSB transmitting timer runs normally, a UE assumes/defaults that the serving cell transmits SSBs of the SSB configuration; after the SSB transmitting timer expires, the UE assumes/defaults that the serving cell does not transmit SSBs of the SSB configuration. For another example, a terminal assumes/defaults that the timer starts running when the SSB configuration is configured by a higher-layer parameter and is activated.

The above schematically describes parameters of an SSB configuration, however the present disclosure is not limited thereto. An SSB configuration may include one of the above parameters, or may further include any combination of two or more parameters, and so on.

In some embodiments, the SSB configuration includes one or more parameters, the parameter(s) being used by the terminal equipment to determine transmission of SSB(s) and/or being used by the terminal equipment to determine an activation state of the SSB configuration.

For example, the one or more parameters may be called SSB transmission activation/indication information/parameter/IE, or SSB transmission state information/parameter/IE. In the following text, “SSB transmission activation/indication information/parameter/IE” will be used to replace “SSB transmission activation/indication information/parameter/IE or SSB transmission state information/parameter/IE”, however the present disclosure is not limited thereto.

In some embodiments, one or more parameters included in the SSB configuration is/are used to indicate whether the SSB configuration is in an activation state, and/or, indicate whether the first serving cell transmits SSB(s) according to the SSB configuration, and/or, indicate whether the first serving cell transmits SSB(s) according to the SSB configuration after the terminal equipment receives the SSB configuration, and/or, indicate whether the first serving cell transmits SSB(s) according to the SSB configuration during a period from a time when the terminal equipment receives the SSB configuration to a time when the terminal equipment receives the RRC and/or MAC CE and/or DCI, and/or, indicate whether the first serving cell transmits SSB(s), and/or, indicate whether the first serving cell transmits SSB(s) after the terminal equipment receives the SSB configuration, and/or, indicate whether the first serving cell transmits SSB(s) during a period from a time when the terminal equipment receives the SSB configuration to a time when the terminal equipment receives the RRC and/or MAC CE and/or DCI.

For example, a terminal equipment receives secondary cell addition/modification configuration information (IE sCellToAddModList), the SCell addition/modification configuration information including SSB configuration related information; a terminal equipment is configured with secondary cell addition/modification configuration IE sCellToAddModList, the sCellToAddModList including an SCelConfig, the SCellConfig IE including a ServingCellConfigCommon E, the ServingCellConfigCommon IE including SSB configuration related parameters, such as ssb-PositionsInflurst, and/or ssb-periodicityServingCell, and/or ssbSubcarrierSpacing, and/or ssb-PositionQCL-r16.

Table 1 schematically shows a situation of an sCellToAddModList IE.

TABLE 1

| | |
|---|---|
| CellGroupConfig ::= | SEQUENCE { |
| cellGroupId | CellGroupId, |
| rlc-BearerToAddModList | SEQUENCE (SIZE(1..maxLC- |
| ID)) OF RLC-BearerConfig | OPTIONAL, -- Need N |
| rlc-BearerToReleaseList | SEQUENCE (SIZE(1..maxLC- |
| ID)) OF LogicalChannelIdentity | OPTIONAL, -- Need N |
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE |
| (1..maxNrofSCells)) OF SCellConfig | OPTIONAL, -- |

Need N

| | |
|---|---|
| sCellToReleaseList | SEQUENCE (SIZE |
| (1..maxNrofSCells)) OF SCellIndex | OPTIONAL, -- |

Need N
...,

| | |
|---|---|
| SCellConfig ::= | SEQUENCE { |
| sCellIndex | SCellIndex, |
| sCellConfigCommon | ServingCellConfigCommon |

OPTIONAL, -- Cond SCellAdd

| | |
|---|---|
| sCellConfigDedicated | ServingCellConfig |

```
OPTIONAL, -- Cond SCellAddMod
  ...,
  [[
```

| | |
|---|---|
| smtc | SSB-MTC |

```
OPTIONAL -- Need S
  ]],
  [[
```

| | |
|---|---|
| sCellState-r16 | ENUMERATED {activated} |

OPTIONAL, -- Cond SCellAddSync

| | |
|---|---|
| secondaryDRX-GroupConfig-r16 | ENUMERATED {true} |

```
OPTIONAL -- Cond DRX-Config2
  ]],
  [[
```

| | |
|---|---|
| preConfGapStatus-r17 | BIT STRING (SIZE (maxNrofGapId-r17)) |

OPTIONAL, -- Cond PreConfigMG

| | |
|---|---|
| goodServingCellEvaluationBFD-r17 | GoodServingCellEvaluation-r17 |

OPTIONAL, -- Need R

| | |
|---|---|
| sCellSIB20-r17 | SetupRelease { SCellSIB20-r17 } |

OPTIONAL -- Need M
]]
}

Table 2 schematically shows a situation of a ServingCellConfigCommon IE.

TABLE 2

| | |
|---|---|
| ServingCellConfigCommon ::= | SEQUENCE { |
| physCellId | PhysCellId |

OPTIONAL, -- Cond HOAndServCellAdd,

| | |
|---|---|
| downlinkConfigCommon | DownlinkConfigCommon |

OPTIONAL, -- Cond HOAndServCellAdd

| | |
|---|---|
| uplinkConfigCommon | UplinkConfigCommon |

OPTIONAL, -- Need M

| | |
|---|---|
| supplementaryUplinkConfig | UplinkConfigCommon |

OPTIONAL, -- Need S

| | |
|---|---|
| n-TimingAdvanceOffset | ENUMERATED { n0, n25600, n39936 } |

OPTIONAL, -- Need S

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}
OPTIONAL, -- Cond AbsFreqSSB

| | |
|---|---|
| ssb-periodicityServingCell | ENUMERATED { ms5, ms10, ms20, |
| ms40, ms80, ms160, spare2, spare1 } | OPTIONAL, -- Need S |
| dmrs-TypeA-Position | ENUMERATED {pos2, pos3}, |
| lte-CRS-ToMatchAround | SetupRelease { |
| RateMatchPatternLTE-CRS } | OPTIONAL, -- Need M |
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternId | OPTIONAL, -- Need N |
| ssbSubcarrierSpacing | SubcarrierSpacing |

OPTIONAL, -- Cond HOAndServCellWithSSB

| | |
|---|---|
| tdd-UL-DL-ConfigurationCommon | TDD-UL-DL-ConfigCommon |

OPTIONAL, -- Cond TDD

| | |
|---|---|
| ss-PBCH-BlockPower | INTEGER (−60..50), |

```
  ...,
  [[
```

| | |
|---|---|
| channelAccessMode-r16 | CHOICE { |
| dynamic | NULL, |

```
    semiStatic
SemiStaticChannelAccessConfig-r16
  }
OPTIONAL, -- Cond SharedSpectrum
```

| | |
|---|---|
| discoveryBurstWindowLength-r16 | ENUMERATED {ms0dot5, ms1, |
| ms2, ms3, ms4, ms5} | OPTIONAL, -- Need R |
| ssb-PositionQCL-r16 | SSB-PositionQCL-Relation-r16 |

OPTIONAL, -- Cond SharedSpectrum

| | |
|---|---|
| highSpeedConfig-r16 | HighSpeedConfig-r16 |

```
OPTIONAL -- Need R
  ]],
  [[
```

| | |
|---|---|
| highSpeedConfig-v1700 | HighSpeedConfig-v1700 |

OPTIONAL, -- Need R

| | |
|---|---|
| channelAccessMode2-r17 | ENUMERATED {enabled} |

OPTIONAL, -- Cond SharedSpectrum2

| | |
|---|---|
| discoveryBurstWindowLength-r17 | ENUMERATED {ms0dot125, ms0dot25, |
| ms0dot5, ms0dot75, ms1, ms1dot25} | OPTIONAL, -- Need R |
| ssb-PositionQCL-r17 | SSB-PositionQCL-Relation-r17 |

OPTIONAL, -- Cond SharedSpectrum2

| | |
|---|---|
| highSpeedConfigFR2-r17 | HighSpeedConfigFR2-r17 |

OPTIONAL, -- Need R

| | |
|---|---|
| uplinkConfigCommon-v1700 | UplinkConfigCommon-v1700 |

OPTIONAL, -- Need R

| | |
|---|---|
| ntn-Config-r17 | NTN-Config-r17 |

```
OPTIONAL -- Need R
  ]],
  [[
```

| | |
|---|---|
| featurePriorities-r17 | SEQUENCE { |
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | |
|---|---|
| sdt-Priority-r17 | FeaturePriority-r17 |

```
OPTIONAL -- Need R
  }
OPTIONAL -- Need R
  ]],
  [[
```

| | |
|---|---|
| ra-ChannelAccess-r17 | ENUMERATED {enabled} |

OPTIONAL -- Cond SharedSpectrum2
]]
}

For example, a secondary cell addition/modification configuration IE (sCellToAddModList) or an SCellConfig IE or a Serving Cell ConfigCommon IE at least includes an SSB transmission activation/indication information/parameter/JE: the SSB transmission activation/indication information/parameter/IE is used to indicate whether the SSB configuration is in an activation state, that is, whether the first serving cell transmits SSB(s) according to the SSB configuration, and/or whether the first serving cell transmits SSB(s) according to the SSB configuration after a terminal equipment receives SSB configuration information.

The SSB transmission activation/indication information/parameter/IL is a newly defined or existing parameter, and a terminal equipment determines, according to a value of the parameter, whether the first serving cell transmits SSB(s) and/or whether the first serving cell transmits SSB(s) according to the SSB configuration. For example, the parameter is named as SSB Transmission State, or SSBState, or on-demandSSBTransmission.

For example, a value of the parameter is ENUMERATED{activated}, or ENUMERATED{true}. When the field/parameter is present or is included in a secondary cell configuration or an SSB configuration, a UE assumes that the SSB configuration is activated; and when the field/parameter is absent, the UE assumes that the SSB configuration is not activated. For another example, a value of the parameter is ENUMERATED{deactivate}, or ENUMERATED{false}. When the field/parameter is present or is included in a secondary cell configuration or an SSB configuration, a UE assumes that the SSB configuration is not activated; and when the field/parameter is absent, the UE assumes that the SSB configuration is activated.

For another example, a value of the parameter is {activated, deactivated}, {true, false}, or {1, 0}. When a value of the parameter is ‘activated’ or ‘true’ or 1, indicating that the SSB configuration is activated, the first serving cell transmits SSB(s) according to the SSB configuration; and when a value of the parameter is ‘false’ or 0, indicating that the SSB configuration is not activated, the first serving cell does not transmit SSB(s) corresponding to the SSB configuration.

For another example, the parameter is named as SSBAbsent, {true, false}, or {1, 0}; when a value of the parameter is ‘true’ or 1, indicating that a current SSB configuration is not activated, the first serving cell does not transmit SSB(s) corresponding to the SSB configuration; and when a value of the parameter is ‘false’ or 0, indicating that a current SSB configuration is activated, the first serving cell transmits SSB(s) corresponding to the SSB configuration.

In some embodiments, the terminal equipment performs L1/L3 measurement and/or synchronization according to the one or more SSB transmission activation/indication information/parameter/IE.

For example, a terminal equipment receives one SSB configuration, and the terminal equipment performs L1/L3 measurement and synchronization according to SSB transmission indication information/parameter/IE.

For example, a terminal equipment is a Rel-19 NES terminal. The terminal equipment receives secondary cell addition/modification configuration information including one SSB configuration, the SSB configuration including the SSB transmission activation/indication information/parameter/IE, the SSB transmission activation/indication information/parameter/IE indicating that the network device transmits the SSB(s) in the first serving cell, the terminal equipment assumes that the first serving cell transmits SSB(s), and the terminal equipment performs measurement and synchronization according to the SSB(s).

For another example, a terminal equipment is a Rel-19 NES terminal. The terminal equipment receives secondary cell addition/modification configuration information including one SSB configuration, the SSB configuration including the SSB transmission indication information/parameter/IE, the SSB transmission indication information/parameter/IE indicating to the terminal equipment that the first serving cell does not transmit the SSB(s), or the first serving cell does not transmit SSB(s) during a period from a time when the terminal equipment receives secondary cell addition/modification configuration information to a time when the terminal equipment receives a secondary cell activation MAC CE, the terminal equipment assumes that the first serving cell does not transmit SSB(s) within the time period, and/or the terminal equipment does not perform measurement and synchronization.

For another example, a terminal equipment is a Rel-19 NES terminal. The terminal equipment receives secondary cell addition/modification configuration information including one SSB configuration, the SSB configuration not including SSB transmission indication information/parameter/IE, the terminal equipment assumes that the first serving cell does not transmit SSB(s), or the first serving cell does not transmit SSB(s) during a period from a time when the terminal equipment receives secondary cell addition/modification configuration information to a time when the terminal equipment receives a secondary cell activation MAC CE, during the period, the terminal equipment does not perform measurement and synchronization; or, the terminal equipment assumes that the first serving cell transmits SSB(s), and the terminal equipment performs measurement and synchronization according to the SSB(s).

In some embodiments, a terminal equipment receives at least two SSB configurations.

For example, a terminal equipment is a Rel-19 NES terminal. The terminal equipment receives secondary cell addition/modification configuration information including a plurality of SSB configurations, the at least two SSB configurations including at least one SSB transmission indication information/parameter/IE, the at least one SSB transmission indication information/parameter/IE indicating that the first serving cell transmits SSB(s), the terminal equipment assumes that the first serving cell transmits SSB(s), and the terminal equipment performs measurement and synchronization according to the SSB(s) corresponding to the SSB transmission indication information/parameter/IE.

For another example, a terminal equipment is a Rel-19 NES terminal. The terminal equipment receives secondary cell addition/modification configuration information including a plurality of SSB configurations, the at least two SSB configurations including at least one SSB transmission indication information/parameter/IE, the at least one SSB transmission indication information/parameter/IE indicating that the first serving cell does not transmit SSB(s), or the first serving cell does not transmit SSB(s) during a period from a time when the terminal equipment receives secondary cell addition/modification configuration information to a time when the terminal equipment receives a secondary cell activation MAC CE, the terminal equipment assumes that the first serving cell does not transmit SSB(s) during the period, and the terminal equipment does not perform measurement and synchronization.

For another example, a terminal equipment is a Rel-19 NES terminal. The terminal equipment receives secondary cell addition/modification configuration information including a plurality of SSB configurations, each of the SSB configurations not including SSB transmission indication information/parameter/IE, the terminal equipment assumes that the first serving cell does not transmit SSB(s), or the first serving cell does not transmit SSB(s) during a period from a time when the terminal equipment receives secondary cell addition/modification configuration information to a time when the terminal equipment receives a secondary cell activation MAC CE, the terminal equipment does not perform measurement and synchronization; or, the terminal equipment assumes that the first serving cell transmits SSB(s), and the terminal equipment performs measurement and synchronization according to the SSB(s).

In some embodiments, one or more parameters for determining transmission of SSB(s) and/or determining an activation state of the SSB configuration is/are not included in the SSB configuration. The terminal equipment assumes that the first serving cell does not transmit SSB(s) or that the first serving cell does not transmit SSB(s) corresponding to the SSB configuration, and the terminal equipment does not perform measurement and synchronization. Or, the terminal equipment assumes that the first serving cell transmits SSB(s) or the first serving cell transmits SSB(s) corresponding to the SSB configuration and/or the first serving cell transmits SSB(s) corresponding to SSB configuration(s) in a default or existing protocol, and the terminal equipment performs measurement and synchronization according to the SSB(s).

In some embodiments, whether the SSB configuration includes one or more parameters is used to indicate whether a serving cell transmits SSB(s), and/or, indicate whether the serving cell transmits SSB(s) after the terminal equipment receives the SSB configuration, and/or, indicate whether the serving cell transmits SSB(s) during a period from a time when the terminal equipment receives the SSB configuration to a time when the terminal equipment receives the RRC and/or MAC CE and/or DCI.

SSB configurations are schematically described above, and indication/activation/triggering of SSB configurations are described below.

In some embodiments, the N SSB configurations are transmitted via RRC, where N≥=1, and the RRC activates/indicates the one SSB configuration.

For example, RRC/higher-layer signaling includes an SSB transmission activation/indication information/parameter/IE or an SSB transmission state information/parameter/IE, the parameter being used to indicate whether the SSB configuration is in an activation state. A terminal equipment determines whether the SSB configuration is activated according to an SSB transmission activation/indication information/parameter/IE or an SSB transmission state information/parameter/IE. The activated SSB is transmitted on the serving cell, and the terminal equipment performs operations such as measurement and/or synchronization according to the activated SSB.

In some embodiments, the one SSB configuration is activated/indicated via a MAC CE; the MAC CE being a secondary cell activation/deactivation MAC CE, or the MAC CE being a MAC CE for activating/triggering/indicating an SSB configuration.

For example, an existing MAC CE, such as an SCell activation/deactivation MAC CE, may be reused.

If a higher layer configures two SSB configurations (e.g., Rel-19 NES), a reserved 1 bit in an SCell activation/deactivation MAC CE may be used for activation/triggering/indication of an SSB configuration; for example, when the reserved 1 bit is 0, it indicates that a current first SSB configuration is activated, and when the reserved 1 bit is 1, it indicates that a second SSB configuration is activated.

If a higher layer configures one SSB configuration (e.g., in existing protocols, a higher layer configures one SSB configuration), and the SSB configuration does not include an SSB configuration activation/indication parameter/IE, or an SSB configuration activation/indication parameter/IE included in an SSB configuration indicates that the SSB configuration is in an inactivation state, the SCell activation/deactivation MAC CE may be used to activate or deactivate the SSB configuration.

In some embodiments, a terminal equipment assumes that after receiving the SCell activation MAC CE, the SSB is transmitted on the secondary cell, and the terminal equipment performs synchronization and measurement operations according to the SSB; the terminal equipment assumes that after receiving the secondary cell deactivation MAC CE, the SSB is not transmitted on the secondary cell, and the terminal equipment does not perform synchronization and measurement operations.

If the serving cell does not transmit an SSB before the terminal equipment receives an SCell activation/deactivation MAC CE, the SCell activation/deactivation MAC CE being at least used to activate one SSB configuration, the SCell activation/deactivation MAC CE is used to trigger an on-demand SSB.

For another example, a MAC CE may be newly defined: the MAC CE is used only for activation/triggering/indication of an SSB configuration; or, the MAC CE is used both for SCell activation/deactivation and for activation/triggering/indication of an SSB configuration.

In some embodiments, the activated SSB configuration is applied starting from application time of the MAC CE.

In some embodiments, if the first serving cell does not transmit SSB(s) before a terminal equipment receives the secondary cell activation/deactivation MAC CE, and the secondary cell activation/deactivation MAC CE is at least used to activate one SSB configuration, the secondary cell activation/deactivation MAC CE is used to trigger/activate/indicate an on-demand SSB.

In some embodiments, if a terminal equipment receives the secondary cell activation MAC CE, the terminal equipment assumes that the first serving cell transmits SSB(s); and/or, if the terminal equipment assumes that the first serving cell transmits SSB(s) after receiving the secondary cell activation MAC CE, the terminal equipment performs measurement and/or synchronization; and/or, if the terminal equipment receives the secondary cell deactivation MAC CE, the terminal equipment assumes that the first serving cell does not transmit SSB(s); and/or, if the terminal equipment assumes that the first serving cell transmits SSB(s) after receiving the secondary cell deactivation MAC CE, the terminal equipment does not perform measurement and/or synchronization.

In some embodiments, the SSB configuration is included in secondary cell addition/modification configuration information, the MAC CE is a secondary cell activation/deactivation MAC CE, and the first serving cell is a secondary cell, and/or, the SSB configuration is included in SIB1 or an RRC reconfiguration message, and the first serving cell is a primary cell.

In some embodiments, if the terminal equipment receives the secondary cell addition/modification configuration information and the secondary cell activation MAC CE in the same time, the terminal equipment does not expect the secondary cell addition/modification configuration information to indicate a serving cell not to transmit SSB(s).

For example, a terminal equipment is a Rel-19 NES terminal, the terminal equipment receives a secondary cell activation MAC CE, the terminal equipment assumes that the first serving cell transmits SSB(s), or the terminal equipment assumes that the first serving cell transmits SSB(s) after receiving a secondary cell activation MAC CE, and the terminal equipment assumes that the terminal equipment performs measurement and/or synchronization operations after receiving a secondary cell activation MAC CE; and/or,
the terminal equipment receives a secondary cell deactivation MAC CE, the terminal equipment assumes that the serving cell does not transmit SSB(s) after receiving a secondary cell deactivation MAC CE, and the terminal equipment does not perform measurement and/or synchronization operations.

For another example, when a terminal equipment receives secondary cell addition/modification configuration information and a secondary cell activation MAC CE at the same time, the terminal equipment does not expect an SSB transmission indication information/parameter/IE included in the secondary cell addition/modification configuration information to indicate that the first serving cell does not transmit SSB(s).

In some embodiments, the one SSB configuration is activated/indicated via DCI; the DCI being group common signaling and/or UE specific signaling.

For example, group common signalling may be used for activation/triggering/indication of an SSB configuration. For example, the group common signalling may be used after secondary cell activation, or for example, the group common signalling may be used after secondary cell configuration, but when a secondary cell is not activated.

For another example, UE specific signalling may be used for activation/triggering/indication of an SSB configuration. For example, existing DCI may be reused for activation/triggering/indication of an SSB configuration; or, DCI may be newly defined for activation/triggering/indication of an SSB configuration.

In some embodiments, the activated SSB configuration starts from an end time of a PDCCH that carries information for activating the SSB configuration.

Contents related to SSB configuration and activation are schematically described above, and SSB signal structures are described below.

FIG. 4 is an example diagram of an SSB in embodiments of the present disclosure. Cases of normal SSB transmission and reduced SSB transmission are shown. A simplified SSB/DRS signal structure may be at least one of the following: the simplified/reduced SSB/DRS only includes PSS and SSS, and does not include PBCHs; the simplified/reduced SSB/DRS includes complete PSS and SSS, and some PBCHs; or the simplified/reduced SSB/DRS includes complete PSS and SSS, and other NES related information; and so on.

In some embodiments, Rel-19 NES does not support simplified/reduced SSB/DRS signal structures, and SSB signal structures are consistent with existing protocols. For example, a reduced SSB only including PSS and SSS in FIG. 4 is not supported. In some other embodiments, Rel-19 NES supports simplified/reduced SSB/DRS signal structures, and SSB signal structures are consistent with existing protocols. For example, a reduced SSB only including PSS and SSS in FIG. 4 is supported.

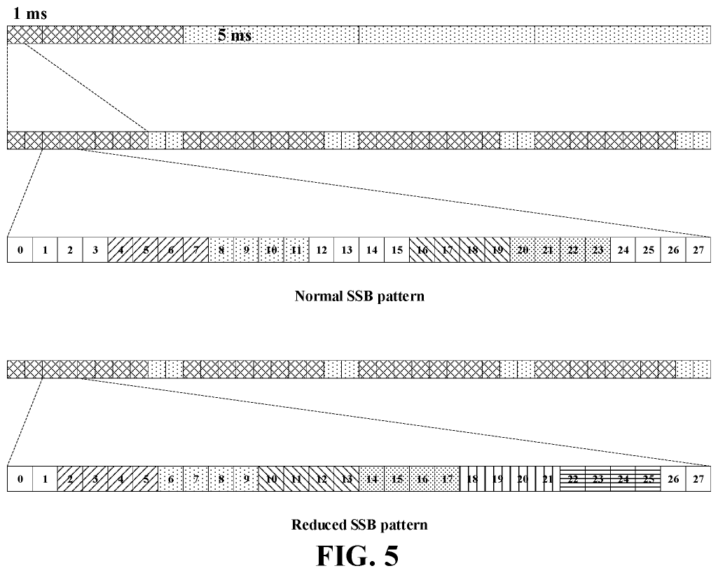

FIG. 5 is an example diagram of an SSB pattern in embodiments of the present disclosure, showing cases of a normal SSB pattern (120 kHz SCS) and a compact/modified SSB pattern. For example, compared with a normal SSB, a compact/modified SSB changes time-domain positions of SSBs within an SSB burst, and shortens/reduces a time-domain interval between every two SSBs.

In some embodiments, Rel-19 NES does not support a compact/modified SSB pattern shown in FIG. 5, and time-frequency positions of SSBs within an SS burst are consistent with existing protocols. In some other embodiments, Rel-19 NES supports a compact/modified SSB pattern shown in FIG. 5.

In some embodiments, a plurality of SSB configurations may be included. Taking f<3 Ghz, scs=15 Khz as an example, for example, SSB configuration 0, SSB configuration 1, SSB configuration 2, SSB configuration 3, and SSB configuration 4 may be included.

For example, FIG. 6 is an example diagram of SSB configuration 0 in embodiments of the present disclosure. For example, SSB configuration 0 may be called a normal SSB (or reference pattern). In an SS burst, there are 4 SSBs with a period of 20 ms, and an RRC parameter is e.g., ssb-PositionsInBurst=1111, ssb-periodicityServingCell=ms20.

For another example, SSB configuration 1 may be called a non-SSB; for example, this configuration may not be configured, and non-transmission of an SSB is achieved via L1/L2 signaling, for example when predefined DCI or MAC CE indicates 0, it indicates a non-SSB.

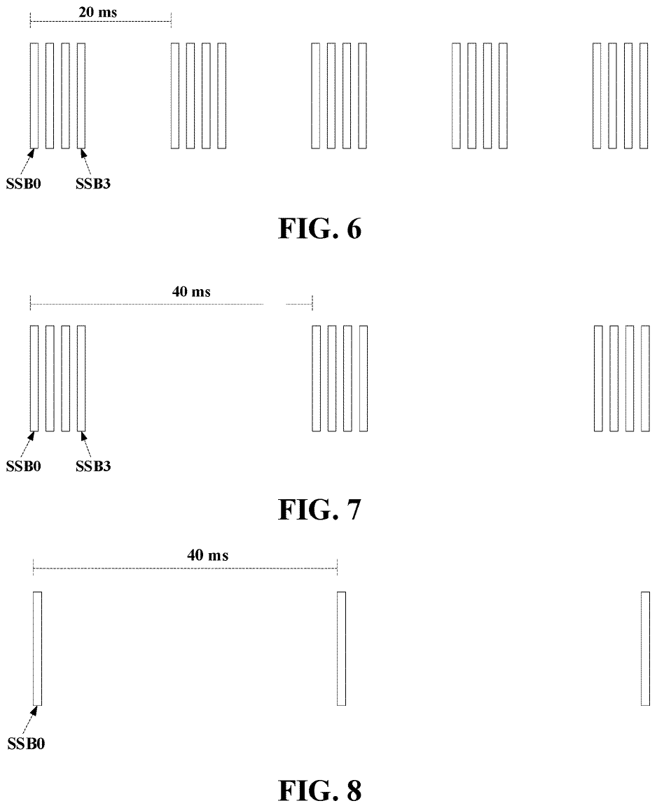

For another example, FIG. 7 is an example diagram of SSB configuration 2 in embodiments of the present disclosure. For example, compared with SSB configuration 0 (normal SSB, or reference pattern), SSB configuration 2 has a longer period. For example, as shown in FIG. 7, in an SS burst, there are 4 SSBs with a period of 40 ms, and an RRC parameter is e.g., ssb-PositionsInBurst=1111, ssb-periodicityServingCell=ms40.

For another example, FIG. 8 is an example diagram of SSB configuration 3 in embodiments of the present disclosure. For example, compared with SSB configuration 0 (normal SSB, or reference pattern), SSB configuration 3 has some beams. For example, as shown in FIG. 8, in an SS burst, there is 1 SSB with a period of 40 ms, and an RRC parameter is e.g., ssb-PositionsInBurst=1000, ssb-periodicityServingCell=ms40.

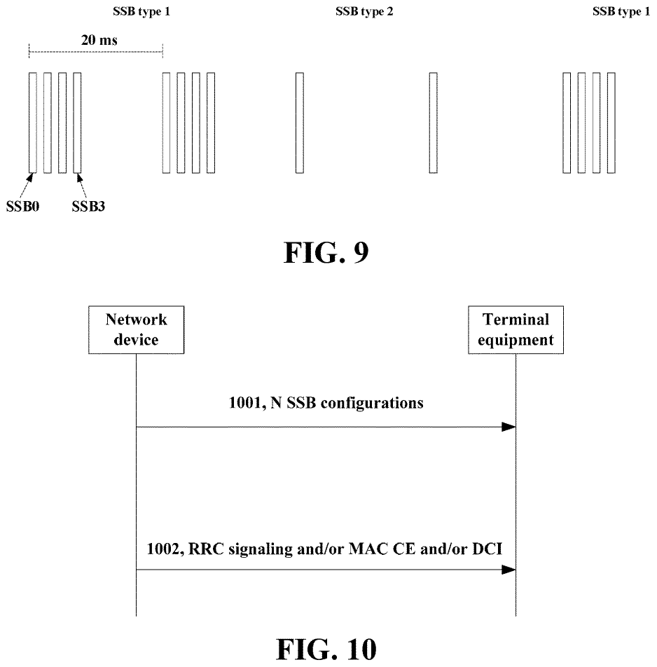

For another example, FIG. 9 is an example diagram of SSB configuration 4 in embodiments of the present disclosure. For example, SSB configuration 4 may have at least two types. For example, as shown in FIG. 9, an SSB type 1 has 4 SSBs in an SS burst, with a period of 20 ms, and SSB type 2 has 1 SSB in an SS burst, with a period of 20 ms.

Only SSB configurations are schematically described above, the present disclosure is not limited thereto, for example one or any combination of the above may be included, and other SSB configurations may also be included. In addition, naming of the above SSB configurations is not limited thereto, and other names are also used.

Each of the above embodiments only exemplarily describes the present disclosure, however the present disclosure is not limited thereto, appropriate modifications may be further made based on each of the above embodiments. For example, each of the above embodiments may be used individually, or one or more of the above embodiments may be combined.

As may be known from the above embodiments, in some scenarios (e.g., an energy-saving mode) of wireless communication applications, a network device and a terminal equipment are able to quickly and flexibly adjust SSB transmission, which is able to not only increase network gains (such as energy-saving gains), but also is able to ensure normal transmission by a terminal equipment.

### Embodiments of a Second Aspect

Embodiments of the present disclosure provide a method for indicating synchronization signal block (SSB), which is described from a network device side. Embodiments of the second aspect may be combined with embodiments of the first aspect, the same contents as embodiments of the first aspect are not further elaborated.

FIG. 10 is a schematic diagram of a method for indicating synchronization signal block (SSB) in embodiments of the present disclosure, as shown in FIG. 10, the method includes:
1001, a network device transmits N synchronization signal block (SSB) configurations to a terminal equipment; and/or,
1002, the network device transmits radio resource control (RRC) signaling and/or a media access control control element (MAC CE) and/or downlink control information (DCI) to the terminal equipment; the RRC signaling and/or MAC CE and/or DCI being used to indicate/activate/trigger one of the N SSB configurations.

It is worth noting that the above FIG. 10 only schematically describes embodiments of the present disclosure, however the present disclosure is not limited thereto. For example, an execution sequence of operations may be adjusted appropriately, moreover some other operations may be added or certain operations therein may be removed. Those skilled in the art may make appropriate modifications according to the above contents, not being limited to records in the above FIG. 10.

In some embodiments, a network device may both transmit N SSB configurations via the same RRC signaling and activate one of N SSB configurations via the RRC signaling. In some other embodiments, a network device may transmit N SSB configurations via one piece of RRC signaling, and activate one of N SSB configurations via another piece of RRC signaling.

In some embodiments, a network device may transmit N SSB configurations via one piece of RRC signaling, and activate one of N SSB configurations via a MAC CE. In some other embodiments, a network device may transmit N SSB configurations via one piece of RRC signaling, and activate one of N SSB configurations via DCI.

In some embodiments, a network device may transmit N SSB configurations via one piece of RRC signaling, and activate M of N SSB configurations via a MAC CE and indicate one of M activated SSB configurations via DCI.

Each of the above embodiments only exemplarily describes the present disclosure, however the present disclosure is not limited thereto, appropriate modifications may be further made based on each of the above embodiments. For example, each of the above embodiments may be used individually, or one or more of the above embodiments may be combined.

As may be known from the above embodiments, in some scenarios (e.g., an energy-saving mode) of wireless communication applications, a network device and a terminal equipment are able to quickly and flexibly adjust SSB transmission, which is able to not only increase network gains (such as energy-saving gains), but also is able to ensure normal transmission by a terminal equipment.

### Embodiments of a Third Aspect

Embodiments of the present disclosure provide an apparatus for indicating synchronization signal block (SSB). The apparatus for example may be a terminal equipment, or may be one or more components or assemblies configured in a terminal equipment, and contents same as those in embodiments of the first aspect are not repeated.

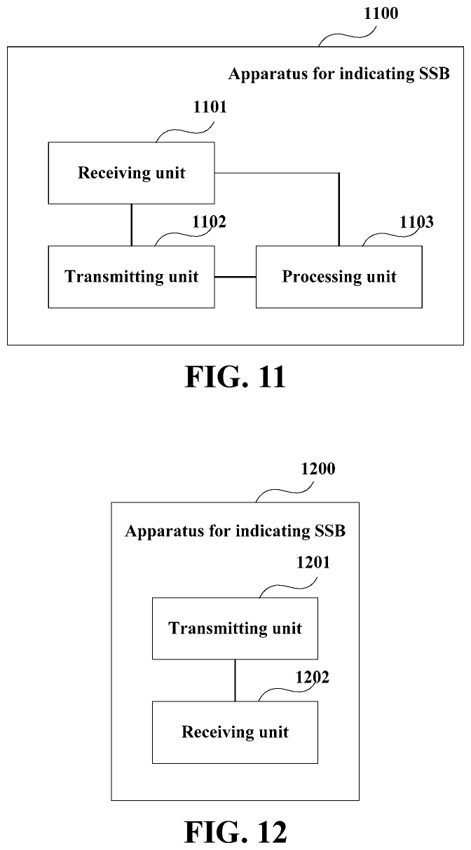

FIG. 11 is a schematic diagram of an apparatus for indicating synchronization signal block (SSB) in embodiments of the present disclosure. As shown in FIG. 11, an apparatus 1100 for indicating synchronization signal block (SSB) includes:
a receiving unit 1101 configured to receive N synchronization signal block (SSB) configurations from a network device, where N≥1; and/or, receive radio resource control (RRC) signaling and/or a media access control control element (MAC CE) and/or downlink control information (DCI); the RRC signaling and/or MAC CE and/or DCI being used to indicate/activate/trigger one of the N SSB configurations.

In some embodiments, as shown in FIG. 11, the apparatus 1100 for indicating synchronization signal block (SSB) may further include:
a transmitting unit 1102 configured to transmit feedback information to a network device.

In some embodiments, the SSB configuration is related to a first serving cell/a first carrier.

In some embodiments, the first serving cell/the first carrier is a secondary cell, and/or, the first serving cell/the first carrier is a primary cell.

In some embodiments, the SSB configuration includes one or more parameters, the parameter(s) being used by a terminal equipment to determine transmission of SSB(s) and/or being used by the terminal equipment to determine an activation state of the SSB configuration.

In some embodiments, one or more parameters included in the SSB configuration is/are used to indicate whether the SSB configuration is in an activation state, and/or, indicate whether the is first serving cell transmits SSB(s) according to the SSB configuration, and/or, indicate whether the first serving cell transmits SSB(s) according to the SSB configuration after the terminal equipment receives the SSB configuration, and/or, indicate whether the first serving cell transmits SSB(s) according to the SSB configuration during a period from a time when the terminal equipment receives the SSB configuration to a time when the terminal equipment receives the RRC and/or MAC CE and/or DCI, and/or, indicate whether the first serving cell transmits SSB(s), and/or, indicate whether the first serving cell transmits SSB(s) after the terminal equipment receives the SSB configuration, and/or, indicate whether the first serving cell transmits SSB(s) during a period from a time when the terminal equipment receives the SSB configuration to a time when the terminal equipment receives the RRC and/or MAC CE and/or DCI.

In some embodiments, as shown in FIG. 11, the apparatus 1100 for indicating synchronization signal block (SSB) may further include:
a processing unit 1103 configured to perform measurement and/or synchronization according to the one or more parameters.

In some embodiments, one or more parameters for determining transmission of SSB(s) and/or determining an activation state of the SSB configuration is/are not included in the SSB configuration.

In some embodiments, a terminal equipment assumes that the first serving cell does not transmit SSB(s) or that the first serving cell does not transmit SSB(s) corresponding to the SSB configuration, and the terminal equipment does not perform measurement and synchronization.

In some embodiments, a terminal equipment assumes that the first serving cell transmits SSB(s) or that the first serving cell transmits SSB(s) corresponding to the SSB configuration, and the terminal equipment performs measurement and synchronization according to the SSB(s).

In some embodiments, whether the SSB configuration includes one or more parameters is used to indicate whether a serving cell transmits SSB(s), and/or, indicate whether the serving cell transmits SSB(s) after a terminal equipment receives the SSB configuration, and/or, indicate whether the serving cell transmits SSB(s) during a period from a time when the terminal equipment receives the SSB configuration to a time when the terminal equipment receives the RRC and/or MAC CE and/or DCI.

In some embodiments, the SSB configuration includes at least one of the following: an SSB period, an SSB time-domain position indication, an SSB subframe/half-frame index/offset or an SSB time offset, an SSB frequency, an SSB subcarrier spacing, SSB power, an SSB duration, the number of SSBs, or an SSB transmitting timer.

In some embodiments, the N SSB configurations are transmitted via RRC, and the RRC activates/indicates the one SSB configuration.

In some embodiments, the one SSB configuration is activated/indicated via a MAC CE; the MAC CE being a secondary cell activation/deactivation MAC CE, or the MAC CE being a MAC CE for activating/triggering/indicating an SSB configuration.

In some embodiments, if a first serving cell does not transmit SSB(s) before a terminal equipment receives the secondary cell activation/deactivation MAC CE, and the secondary cell activation/deactivation MAC CE is at least used to activate one SSB configuration, the secondary cell activation/deactivation MAC CE is used to trigger/activate/indicate an on-demand SSB.

In some embodiments, if a terminal equipment receives the secondary cell activation MAC CE, the terminal equipment assumes that the first serving cell transmits SSB(s); and/or if the terminal equipment receives the secondary cell activation MAC CE, the terminal equipment performs measurement and/or synchronization; and/or if the terminal equipment receives the secondary cell deactivation MAC CE, the terminal equipment assumes that the first serving cell does not transmit SSB(s); and/or if the terminal equipment receives the secondary cell deactivation MAC CE, the terminal equipment does not perform measurement and/or synchronization.

In some embodiments, the one SSB configuration is activated/indicated via DCI; the DCI being group common signaling and/or UE specific signaling.

In some embodiments, the SSB configuration is included in secondary cell addition/modification configuration information, the MAC CE is a secondary cell activation MAC CE, and/or, the SSB configuration is included in SIB1 or an RRC reconfiguration message.

In some embodiments, if a terminal equipment receives the secondary cell addition/modification configuration information and the secondary cell activation MAC CE in the same time, the terminal equipment does not expect the secondary cell addition/modification configuration information to indicate a serving cell not to transmit SSB(s).

It is worth noting that the above text only describes components or modules related to the present disclosure, however the present disclosure is not limited thereto. The apparatus 1100 for indicating synchronization signal block (SSB) may further include other components or modules. For detailed contents of these components or modules, relevant technologies may be referred to.

Moreover, for simplicity, FIG. 11 only exemplarily shows a connection relationship or signal flow between components or modules, however those skilled in the art should know that various relevant technologies such as bus connection may be used. Each of the above components or modules may be implemented via a hardware facility such as a processor, a memory, a transmitter, a receiver, etc. Embodiments of the present disclosure do not impose limitations thereto.

Through embodiments of the present disclosure, in some scenarios (e.g., an energy-saving mode) of wireless communication applications, a network device and a terminal equipment are able to quickly and flexibly adjust SSB transmission, which is able to not only increase network gains (such as energy-saving gains), but also is able to ensure normal transmission by a terminal equipment.

### Embodiments of a Fourth Aspect

Embodiments of the present disclosure provide an apparatus for indicating synchronization signal block (SSB). The apparatus for example may be a network device, or may be one or more components or assemblies configured in a network device, and contents same as those in embodiments of the first and second aspects are not repeated.

FIG. 12 is a schematic diagram of an apparatus for indicating synchronization signal block (SSB) in embodiments of the present disclosure. As shown in FIG. 12, an apparatus 1200 for indicating synchronization signal block (SSB) includes:
a transmitting unit 1201 configured to transmit N synchronization signal block (SSB) configurations to a terminal equipment, where N≥1; and/or, transmit radio resource control (RRC) signaling and/or a media access control control element (MAC CE) and/or downlink control information (DCI) to the terminal equipment; the RRC signaling and/or MAC CE and/or DCI being used to indicate/activate/trigger one of the N SSB configurations.

In some embodiments, as shown in FIG. 12, the apparatus 1200 for indicating synchronization signal block (SSB) may further include:
a receiving unit 1202 configured to receive feedback information from a terminal equipment.

It is worth noting that the above text only describes components or modules related to the present disclosure, however the present disclosure is not limited thereto. The apparatus 1200 for indicating synchronization signal block (SSB) may further include other components or modules. For detailed contents of these components or modules, relevant technologies may be referred to.

Moreover, for simplicity, FIG. 12 only exemplarily shows a connection relationship or signal flow between components or modules, however those skilled in the art should know that various relevant technologies such as bus connection may be used. Each of the above components or modules may be implemented via a hardware facility such as a processor, a memory, a transmitter, a receiver, etc. Embodiments of the present disclosure do not impose limitations thereto.

Through embodiments of the present disclosure, in some scenarios (e.g., an energy-saving mode) of wireless communication applications, a network device and a terminal equipment are able to quickly and flexibly adjust SSB transmission, which is able to not only increase network gains (such as energy-saving gains), but also is able to ensure normal transmission by a terminal equipment.

### Embodiments of a Fifth Aspect

Embodiments of the present disclosure further provide a communication system, FIG. 1 may be referred to, contents same as those in embodiments of the first to fourth aspects are not further elaborated.

In some embodiments, a communication system 100 at least may include:
a network device configured to transmit N synchronization signal block (SSB) configurations to a terminal equipment, where N≥1; and/or, transmit radio resource control (RRC) signaling and/or a media access control control element (MAC CE) and/or downlink control information (DCI) to the terminal equipment; and
a terminal equipment configured to receive the N synchronization signal block (SSB) configurations; and/or, receive radio resource control (RRC) signaling and/or a media access control control element (MAC CE) and/or downlink control information (DCI); the RRC signaling and/or MAC CE and/or DCI being used to indicate/activate/trigger one of the N SSB configurations.

Embodiments of the present disclosure further provide a terminal equipment, but the present disclosure is not limited thereto, it may further be another device.

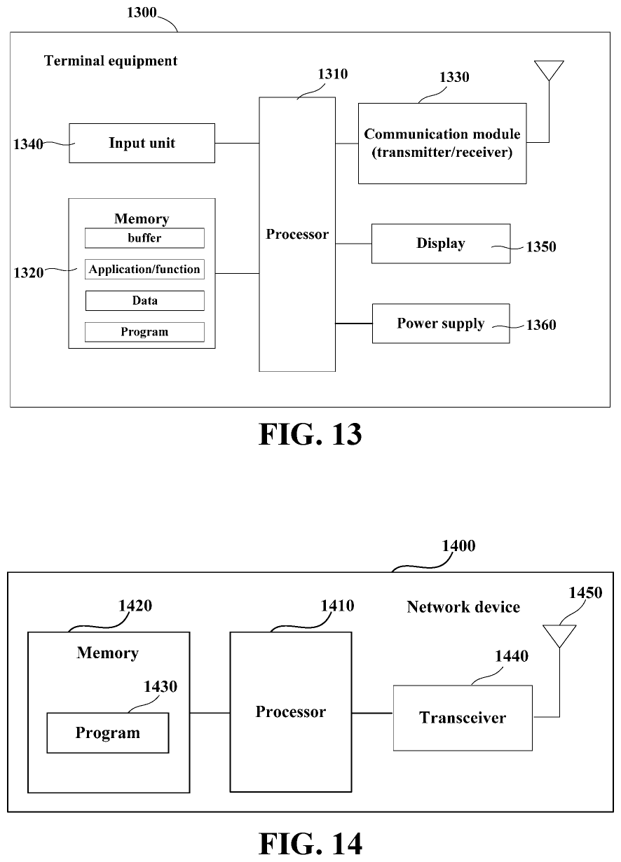

FIG. 13 is a schematic diagram of a terminal equipment in embodiments of the present disclosure. As shown in FIG. 13, the terminal equipment 1300 may include a processor 1310 and a memory 1320; the memory 1320 stores data and programs, and is coupled to the processor 1310. It is worth noting that this figure is exemplary, other types of structures may also be used to supplement or replace this structure, to implement a telecommunication function or other functions.

For example, the processor 1310 may be configured to execute a program to implement the method for indicating synchronization signal block (SSB) described in embodiments of the first aspect. For example, the processor 1310 may be configured to perform the following control: receiving N synchronization signal block (SSB) configurations from a network device, where N≥1; and/or, receiving radio resource control (RRC) signaling and/or a media access control control element (MAC CE) and/or downlink control information (DCI); the RRC signaling and/or MAC CE and/or DCI being used to indicate/activate/trigger one of the N SSB configurations.

As shown in FIG. 13, the terminal equipment 1300 may further include: a communication module 1330, an input unit 1340, a display 1350, and a power supply 1360. Functions of the above components are similar to related arts, and are not further elaborated here. It is worth noting that the terminal equipment 1300 does not have to include all components shown in FIG. 13, said components are not indispensable. Moreover, the terminal equipment 1300 may further include components not shown in FIG. 13, related arts may be referred to.

Embodiments of the present disclosure further provide a network device, for example it may be a base station, but the present disclosure is not limited thereto, or it may further be another network device.

FIG. 14 is a composition schematic diagram of a network device in embodiments of the present disclosure. As shown in FIG. 14, a network device 1400 may include: a processor 1410 (such as a central processing unit (CPU)) and a memory 1420; the memory 1420 is coupled to the processor 1410. The memory 1420 may store various data; moreover, further stores a program 1430 for information processing, and executes the program 1430 under the control of the processor 1410.

For example, the processor 1410 may be configured to execute a program to implement the method for indicating synchronization signal block (SSB) described in embodiments of the second aspect. For example, the processor 1410 may be configured to perform the following control: transmitting N synchronization signal block (SSB) configurations to a terminal equipment, where N≥1; and/or, transmitting radio resource control (RRC) signaling and/or a media access control control element (MAC CE) and/or downlink control information (DCI) to the terminal equipment; the RRC signaling and/or MAC CE and/or DCI being used to indicate/activate/trigger one of the N SSB configurations.

In addition, as shown in FIG. 14, the network device 1400 may further include a transceiver 1440 and an antenna 1450, etc., wherein functions of said components are similar to related arts and are not further elaborated here. It is worth noting that the network device 1400 does not have to include all components shown in FIG. 14. Moreover, the network device 1400 may further include components not shown in FIG. 14, related arts may be referred to.

Embodiments of the present disclosure further provide a computer program, wherein when the program is executed in a terminal equipment, the program enables the terminal equipment to execute the method for indicating synchronization signal block (SSB) described in embodiments of the first aspect.

Embodiments of the present disclosure further provide a storage medium in which a computer program is stored, wherein the computer program enables a terminal equipment to execute the method for indicating synchronization signal block (SSB) described in embodiments of the first aspect.

Embodiments of the present disclosure further provide a computer program, wherein when the program is executed in a network device, the program enables the network device to execute the method for indicating synchronization signal block (SSB) described in embodiments of the second aspect.

Embodiments of the present disclosure further provide a storage medium in which a computer program is stored, wherein the computer program enables a network device to execute the method for indicating synchronization signal block (SSB) described in embodiments of the second aspect.

Apparatuses and methods in the present disclosure may be implemented by hardware, or may be implemented by combining hardware with software. The present disclosure relates to such a computer readable program that when the program is executed by a logic component, the logic component is able to implement apparatuses described in the above text or a constituent component, or the logic component is able to implement various methods or steps described in the above text. The present disclosure further relates to a storage medium storing the above programs, such as a hard disk, a magnetic disk, an optical disk, a DVD, a flash memory and the like.

Methods/apparatuses described by combining with embodiments of the present disclosure may be directly embodied as hardware, a software module executed by a processor, or a combination of the two. For example, one or more of functional block diagrams shown in drawings or one or more combinations of functional block diagrams may correspond to software modules of a computer program process, or may correspond to hardware modules. These software modules may respectively correspond to steps shown in drawings. These hardware modules may be implemented by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM, or any other form of storage medium known in the art. A storage medium may be coupled to a processor, thus enabling the processor to read information from the storage medium and write information into the storage medium, or the storage medium may be a constituent part of a processor. A processor and a storage medium may be located in an ASIC. The software module may be stored in a memory of a mobile terminal, or may be stored in a memory card that may be inserted into a mobile terminal. For example, if a device (e.g., a mobile terminal) adopts a MEGA-SIM card with a larger capacity or a flash memory apparatus with a large capacity, the software module may be stored in the MEGA-SIM card, or in the flash memory apparatus with a large capacity.

One or more of functional block diagrams described in drawings or one or more combinations of functional block diagrams may be implemented as a general-purpose processor for performing functions described in the present disclosure, a digital signal processor (DSP), an application-specific integrated circuit (ASIC), a field-programmable gate array (FPGA) or other programmable logic device, a discrete gate or a transistor logic device, a discrete hardware component, or any appropriate combination thereof. One or more of functional block diagrams described in drawings or one or more combinations of functional block diagrams may further be implemented as a combination of computing devices, such as a combination of a DSP and a microprocessor, a plurality of microprocessors, one or more microprocessors combined and communicating with a DSP, or any other such configuration.

The present disclosure is described above by combining with specific implementations, however persons skilled in the art should clearly know that these descriptions are exemplary and do not limit protection scopes of the present disclosure. Persons skilled in the art may make various variations and amendments to the present disclosure according to spirits and principles of the present disclosure, these variations and amendments are also within scopes of the present disclosure.

As for implementations including the above embodiments, the following supplements are further disclosed:

1. A method for indicating synchronization signal block (SSB), including that:
a terminal equipment receives N synchronization signal block (SSB) configurations from a network device, where N≥1; and/or,
the terminal equipment receives radio resource control (RRC) signaling and/or a media access control control element (MAC CE) and/or downlink control information (DCI); the RRC signaling and/or MAC CE and/or DCI being used to indicate/activate/trigger one of the N SSB configurations.

2. A method for indicating synchronization signal block (SSB), including that:
a network device transmits N synchronization signal block (SSB) configurations to a terminal equipment, where N≥1; and/or,
the network device transmits radio resource control (RRC) signaling and/or a media access control control element (MAC CE) and/or downlink control information (DCI) to the terminal equipment; the RRC signaling and/or MAC CE and/or DCI being used to indicate/activate/trigger one of the N SSB configurations.

3. A terminal equipment, including a memory and a processor, the memory storing a computer program, and the processor being configured to execute the computer program to implement the method for indicating synchronization signal block (SSB) according to supplement 1.

4. A network device, including a memory and a processor, the memory storing a computer program, and the processor being configured to execute the computer program to implement the method for indicating synchronization signal block (SSB) according to supplement 2.

5. A computer program product configured to enable a terminal equipment to perform the method for indicating synchronization signal block (SSB) according to supplement 1.

6. A computer program product configured to enable a network device to perform the method for indicating synchronization signal block (SSB) according to supplement 2.

What is claimed is:

1. An apparatus for indicating synchronization signal block (SSB), configured in a terminal equipment, the apparatus comprising:
a receiver configured to receive N SSB configurations from a network device, where N≥2, wherein the N SSB configurations are carried by radio resource control (RRC) signaling, and
processor circuitry configured to activate at least one of the N SSB configurations.

2. The apparatus according to claim 1, wherein
the receiver is further configured to receive media access control control element (MAC CE) or downlink control information (DCI); and
the processor circuitry is configured to activate at least one of the N SSB configurations according to the MAC CE or the DCI.

3. The apparatus according to claim 1, wherein
the processor circuitry is configured to activate at least one of the N SSB configurations according to the RRC signaling.

4. The apparatus according to claim 1, wherein at least one of the N SSB configurations is related to a first serving cell, the first serving cell is a secondary cell or a primary cell.

5. The apparatus according to claim 4, wherein the first serving cell is a secondary cell,
wherein at least one of the N SSB configurations is comprised in a secondary cell configuration (SCellConfig) of the first serving cell, and/or,
a SSB configuration list is comprised in a secondary cell configuration (SCellConfig) of the first serving cell, the SSB configuration list at least comprising at least one of the N SSB configurations.

6. The apparatus according to claim 1, wherein at least one of the N SSB configurations comprises at least one of the following: SSB period (ssb-Periodicity-r19), SSB frequency, SSB time-domain position indication (ssb-PositionsInBurst-r19), SSB half-frame index, SSB time offset, SSB subcarrier spacing, SFN offset, or the number of SSBs.

7. The apparatus according to claim 1, wherein one of the N SSB configurations is a SSB configuration being in/being supported by the existing protocol; and/or
one of the N SSB configurations comprises at least one default configuration, wherein the at least one default configuration is a SSB configuration being in/being supported by the existing protocol.

8. The apparatus according to claim 1, wherein at least one of the N SSB configurations comprises a parameter, the parameter being used by the terminal equipment to determine an activation state of the at least one of the N SSB configurations.

9. The apparatus according to claim 8, wherein a value of the parameter used by the terminal equipment to determine an activation state of the at least one of the N SSB configurations is ENUMERATED{activated}.

10. The apparatus according to claim 1, wherein the RRC signaling being used to carry the N SSB configurations is further used to activate one of the N SSB configurations, or
the RRC signaling being used to carry the N SSB configurations and the RRC signaling being used to activate one of the N SSB configurations are one RRC signaling.

11. The apparatus according to claim 1, wherein media access control control element (MAC CE) being used to activate one of the N SSB configurations is dedicated to activate the one of the N SSB configurations and/or indicate at least one of the N SSB configurations; and/or
an activated one SSB configuration is applied from an application time of the MAC CE.

12. The apparatus according to claim 1, wherein the at least one of the N SSB configurations is activated/indicated via downlink control information (DCI); the DCI being group common signaling.

13. An apparatus for indicating synchronization signal block (SSB), configured in a network device, the apparatus comprising:
a transmitter configured to
transmit N SSB configurations to a terminal equipment, where N≥2, wherein the N SSB configurations are carried by RRC (radio resource control) signaling; and/or,
transmit RRC signaling and/or MAC CE (media access control control element), or, DCI (downlink control information); the RRC signaling or MAC CE or DCI being used to activate at least one of the N SSB configurations.

14. The apparatus according to claim 13, wherein at least one of the N SSB configurations is related to a first serving cell, the first serving cell is a secondary cell or a primary cell.

15. The apparatus according to claim 14, wherein the first serving cell is a secondary cell,
wherein at least one of the N SSB configurations is comprised in a secondary cell configuration (SCellConfig) of the first serving cell, and/or,
a SSB configuration list is comprised in a secondary cell configuration (SCellConfig) of the first serving cell, the SSB configuration list at least comprising at least one of the N SSB configurations.

16. The apparatus according to claim 13, wherein at least one of the N SSB configurations comprises at least one of the following: SSB period (ssb-Periodicity-r19), SSB frequency, SSB time-domain position indication (ssb-PositionsInBurst-r19), SSB half-frame index, SSB time offset, SSB subcarrier spacing, SFN offset, or the number of SSBs.

17. The apparatus according to claim 13, wherein one of the N SSB configurations is a SSB configuration being in/being supported by the existing protocol; and/or
one of the N SSB configurations comprises at least one default configuration, wherein the at least one default configuration is a SSB configuration being in/being supported by the existing protocol.

18. The apparatus according to claim 13, wherein at least one of the N SSB configurations comprises a parameter, the parameter being used by the terminal equipment to determine an activation state of the at least one of the N SSB configurations;
wherein a value of the parameter used by the terminal equipment to determine an activation state of the at least one of the N SSB configurations is ENUMERATED{activated}.

19. The apparatus according to claim 13, wherein the RRC signaling being used to carry the N SSB configurations is further used to activate one of the N SSB configurations, or
the RRC signaling being used to carry the N SSB configurations and the RRC signaling being used to activate one of the N SSB configurations are one RRC signaling.

20. A communication system, comprising:
a network device configured to transmit N SSB (synchronization signal block) configurations, where N≥2, wherein the N SSB configurations are carried by RRC (radio resource control) signaling; and/or, transmit RRC signaling and/or MAC CE (media access control control element), or, DCI (downlink control information); the RRC signaling or MAC CE or DCI being used to activate at least one of the N SSB configurations;
a terminal equipment configured to receive the N SSB configurations, and/or, receive the RRC signaling and/or the MAC CE, or, the DCI.
